(19) United States
(12) Patent Application Publication
(10) Pub. No.: US 2026/0125256 A1
(43) Pub. Date: May 7, 2026

(54) LOAD RETAINING APPARATUS FOR A FORKLIFT

(71) Applicant: Ziad Adam, Hinchinbrook (AU)

(72) Inventor: Ziad Adam, Hinchinbrook (AU)

(21) Appl. No.: 18/940,441

(22) Filed: Nov. 7, 2024

(51) Int. Cl. B66F 9/18

(52) U.S. Cl. CPC B66F 9/18

(57) ABSTRACT

A load retaining apparatus for retaining a load on forklift prongs a body with an upper surface for supporting the load and which defines a stop-receiving opening in the upper surface of the body. A stop is mounted to the body and is movable between a stored position and a deployed position. When in the stored position, the stop is positioned below the upper surface of the body, and in the deployed position the stop extends upwardly through the stop-receiving opening of the body. An actuator is operatively coupled to the stop and is configured to move the stop from the stored position to the deployed position when the load is positioned on the upper surface of the body.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to load retaining apparatuses and more particularly pertains to a new load retaining apparatus for retaining a load on forklift prongs or other material handling devices.

### (2) Description of Related Art Including Information Disclosed Under 37 CFR 1.97 and 1.98

The prior art relates to material handling apparatuses including various forms of forklift tines or prongs. U.S. Pat. No. 5,897,286 discloses pallet stops which mount to forklift tines to align a pallet on the forklift tines and to prevent the front ends of the tines from protruding out of the pallet. However, the prior art fails to describe a load retainer mechanism mounted in a forklift tine which actuates a stop in front of a load to prevent the load from sliding forward off of the forklift tine.

### BRIEF SUMMARY OF THE INVENTION

An embodiment of the disclosure meets the needs presented above by generally comprising a body with an upper surface for supporting a load and which defines a stop-receiving opening in the upper surface of the body. A stop is mounted to the body and is movable between a stored position and a deployed position. When in the stored position, the stop is positioned below the upper surface of the body, and in the deployed position the stop extends upwardly through the stop-receiving opening of the body. An actuator is operatively coupled to the stop and is configured to move the stop from the stored position to the deployed position when the load is positioned on the upper surface of the body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a load retaining apparatus according to an embodiment of the disclosure.

FIG. 2 is a top view of a pair of embodiments of the disclosure in-use on a pair of forklift prongs.

FIG. 3 is a cross section view of an embodiment of the disclosure taken from Line 3-3 in FIG. 2 in which a stop is in a deployed position.

FIG. 4 is a cross section view of an embodiment of the disclosure taken from Line 3-3 in FIG. 2 in which a stop is in a stored position.

FIG. 5 is a rear view of an embodiment of the disclosure.

FIG. 6 is a top view of an embodiment of the disclosure.

FIG. 7 is a side view of an embodiment of the disclosure in-use on a forklift prong and supporting a load thereon.

FIG. 8 is a side view of an embodiment of the disclosure in-use on a forklift prong and supporting a load thereon.

FIG. 9 is a side view of an embodiment of the disclosure in-use on a forklift prong and supporting a load thereon.

### DETAILED DESCRIPTION OF THE INVENTION

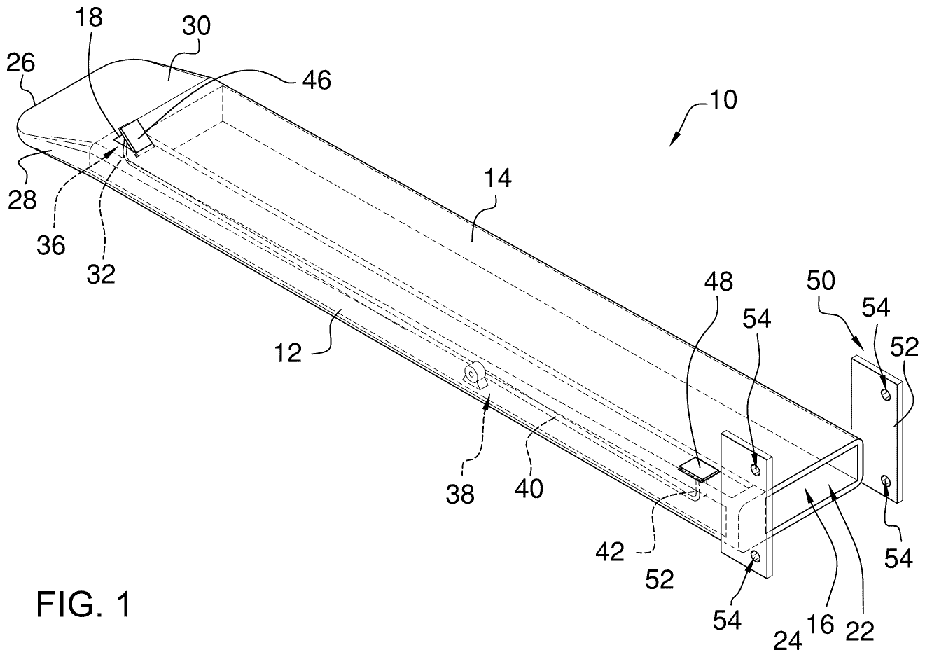

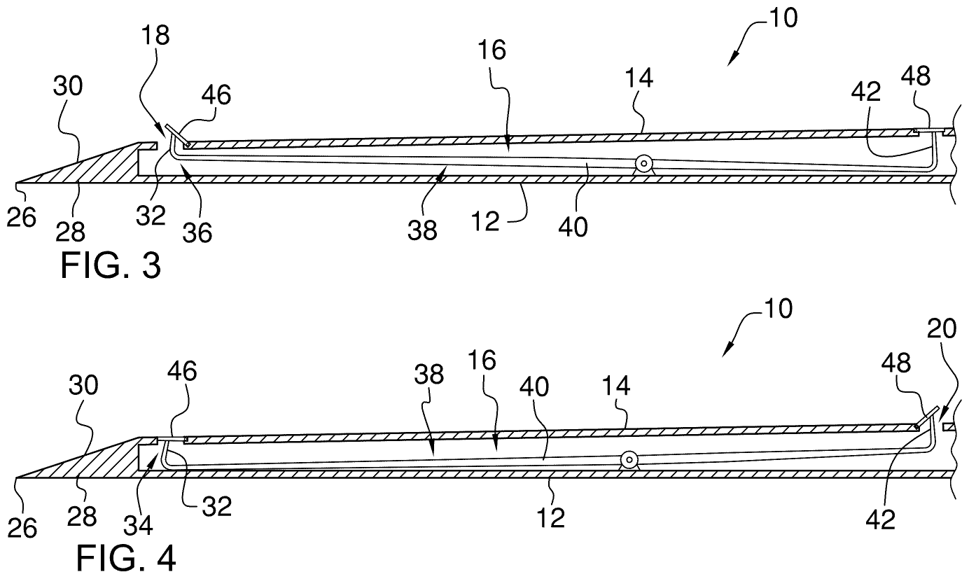

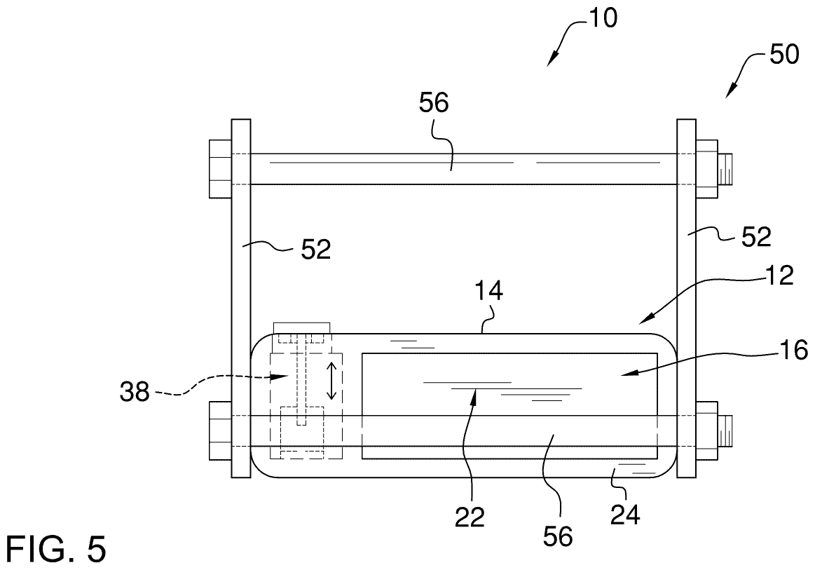

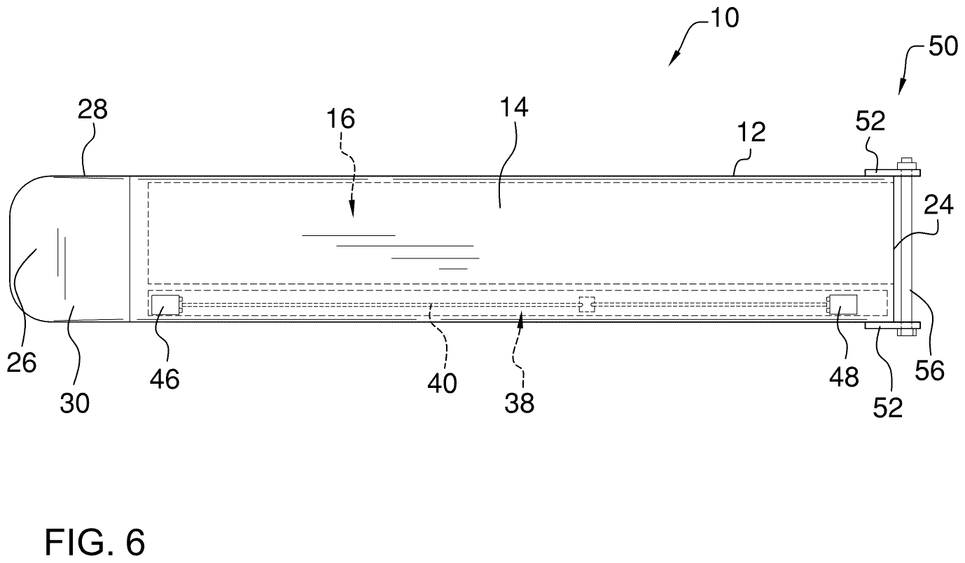

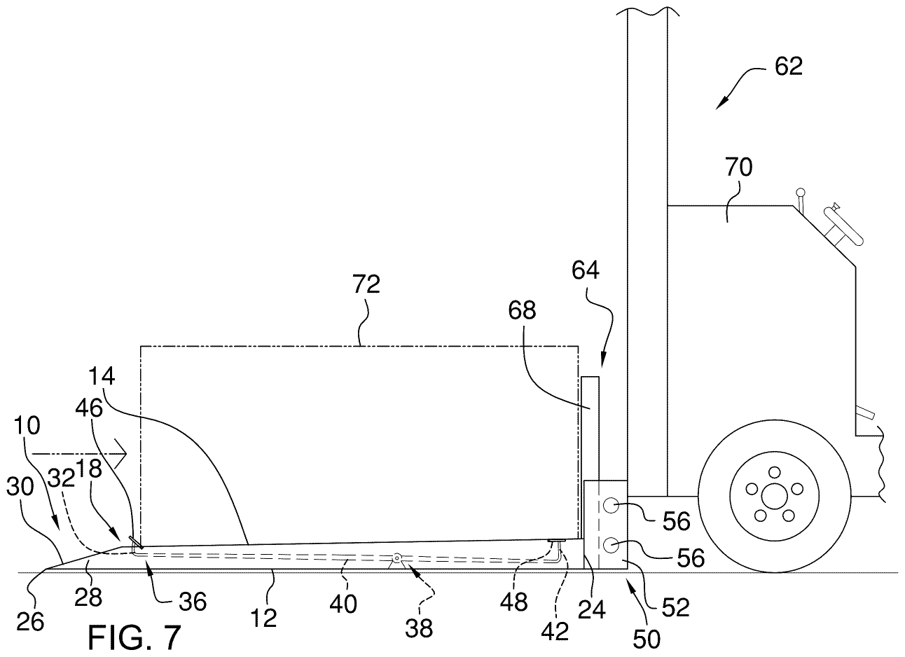

With reference now to the drawings, and in particular to FIGS. 1 through 9 thereof, a new load retaining apparatus embodying the principles and concepts of an embodiment of the disclosure and generally designated by the reference numeral 10 will be described.

As best illustrated in FIGS. 1 through 9, the load retaining apparatus 10 generally comprises a body 12 with an upper surface 14 for supporting a load 72. The body 12 defines a stop-receiving opening 18 in the upper surface 14 of the body 12 and an interior space 16 within the body 12. The body 12 also defines an opening 22 to the interior space 16 at the back end 24 of the body 12. The interior space 16 is sized and configured to receive a prong 64 of a forklift 62 therein through the opening 22. The body 12 may also be shaped and sized to fit over a pallet jack or other material handling device. The body 12 also has a front portion 28 with a top surface 30 which is angled downwardly from the upper surface 14 of the body 12 to a front end 26 of the body 12.

A stop 32 is mounted to the body 12 and is movable between a stored position 34 and a deployed position 36. In the stored position 34, the stop 32 is positioned below the upper surface 14 of the body 12, and in the deployed position 36 the stop 32 extends upwardly through the stop-receiving opening 18 of the body 12. The stop 32 is biased toward the stored position 34 via gravity, although springs, elastic bands, or other biasing members may be used. An actuator 38 comprising a lever 40 is coupled to the stop 32 and is movable to urge the stop 32 between the stored position 34 and the deployed position 36. The lever 40 is pivotably coupled to the body 12. The actuator 38 is configured to move the stop 32 from the stored position 34 to the deployed position 36. When the actuator 38 is deactivated by removing the load 72 from the body 12, the stop 32 biases to the stored position 34. In other embodiments, the actuator 38 may actively move the stop 32 from the deployed position 36 to the stored position 34 when the load 72 is removed from the body 12.

A stop opening door 46 is pivotably coupled to the body 12. The stop opening door 46 is movable to alternately open and close the stop-receiving opening 18. In other embodiments, the stop opening door 46 may be slidably coupled or otherwise movably coupled to the body 12.

A mounting assembly 50 is coupled to the body 12 at the back end 24 which is configured to attach the body 12 to the prong 64 of the forklift 62. The mounting assembly 50 comprises a pair of plates 52 spaced laterally from each other with respect to the body 12. Each plate 52 of the pair of plates 52 defines a pair of holes 54, and each hole 54 of the pair of holes 54 of each plate 52 aligns with an associated hole 54 of the pair of holes 54 of another plate 52 of the pair of plates 52. The body 12 may be secured over a horizontal portion 66 of the prong 64 by inserting a fastener 56 such as a bolt or a rod through one hole 54 in each of the plates 52 behind an upright portion 68 of the prong 64 and securing the fastener 56 via a nut, a clamp, a latch, or other suitable attachment device. The holes 54 of each plate 52 may be offset in a front-to-back direction with respect to the body 12 to adapt to different prong 64 shapes and sizes of different vehicles.

The mounting assembly 50 itself also may comprise a clamp, a latch, or other suitable attachment device which engages directly with the prong 64 to attach the body 12 to the prong 64. In some embodiments, the load retaining apparatus 10 may be integrated into the prong 64. For example, the body 12 may be integrally formed with the prong 64 rather than being removably attachable to the prong 64. In other embodiments, the load retaining apparatus 10 may be integrated into another material handling apparatus.

The actuator 38 may comprise any of various devices for detecting the load 72 on the upper surface 14 of the body 12 and imparting a force on the stop 32 to move the stop 32 to the deployed position 36. For example, in one embodiment shown in FIGS. 1 through 7, the actuator 38 comprises a protrusion 42 which is coupled to the lever 40 opposite the stop 32 and which is movable through an actuator-receiving opening 20 in the upper surface 14 of the body 12. The actuator-receiving opening 20 is positioned closer to a back end 24 of the body 12 than the stop-receiving opening 18 is. The protrusion 42 extends through the actuator-receiving opening 20 when the stop 32 is positioned in the stored position 34 and is depressible through the actuator-receiving opening 20 to urge the stop 32 to the deployed position 36. An actuator opening door 48 is coupled to the body 12 and is movable to alternately open and close the actuator-receiving opening 20. The actuator opening door 48 is pivotable with respect to the body 12 but may be slidable or otherwise movable.

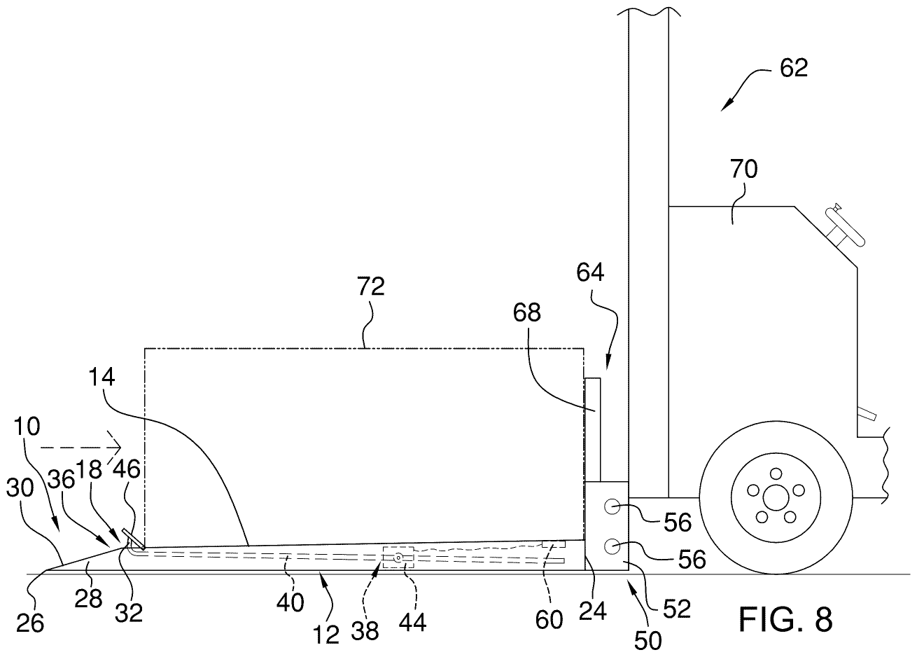

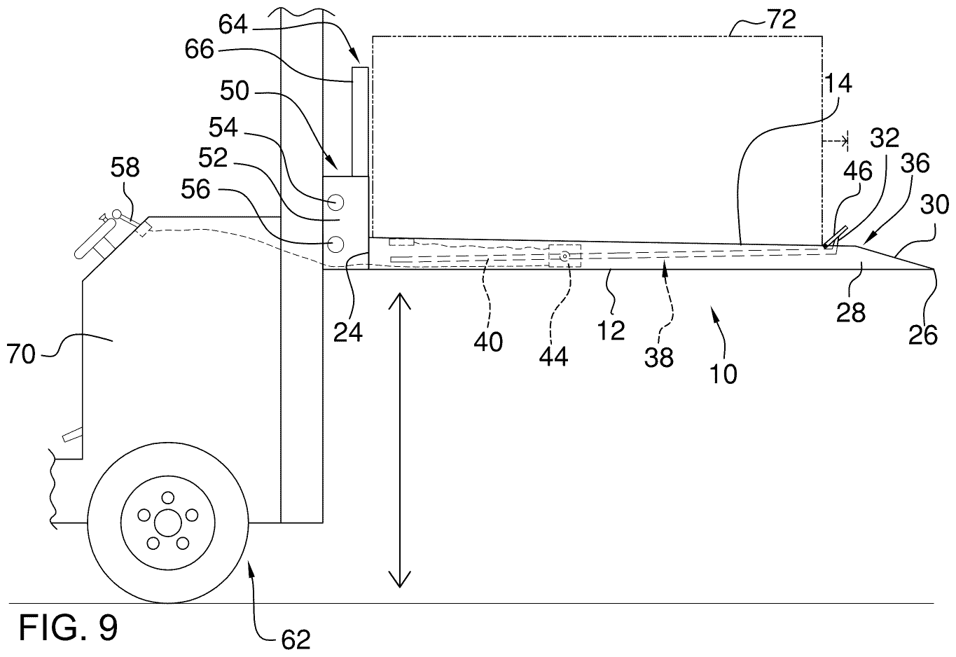

With reference to FIGS. 8 and 9, the actuator 38 may comprise a motor 44 or other drive mechanism which is attached to the lever 40 and may be activated to urge the stop 32 into the deployed position 36. In FIG. 8, a user interface 58 is operatively coupled to the drive mechanism. The user interface 58 is mounted to a frame 70 of the forklift 62 and electrically coupled to the motor 44 via electrical wire. The electrical wire may be releasable from the user interface 58 to facilitate removal of the body 12 from the prong 64, or the user interface 58 may operate via wireless signals sent to the motor 44. The user interface 58 also may be removable from the frame 70.

With reference to FIG. 9, a sensor 60 is mounted to the body 12 and is configured to activate the motor 44 or other drive mechanism to urge the stop 32 into the deployed position 36 when it senses the load 72 on the prong 64. The sensor 60 may be a proximity sensor, a weight sensor, or any other suitable sensor.

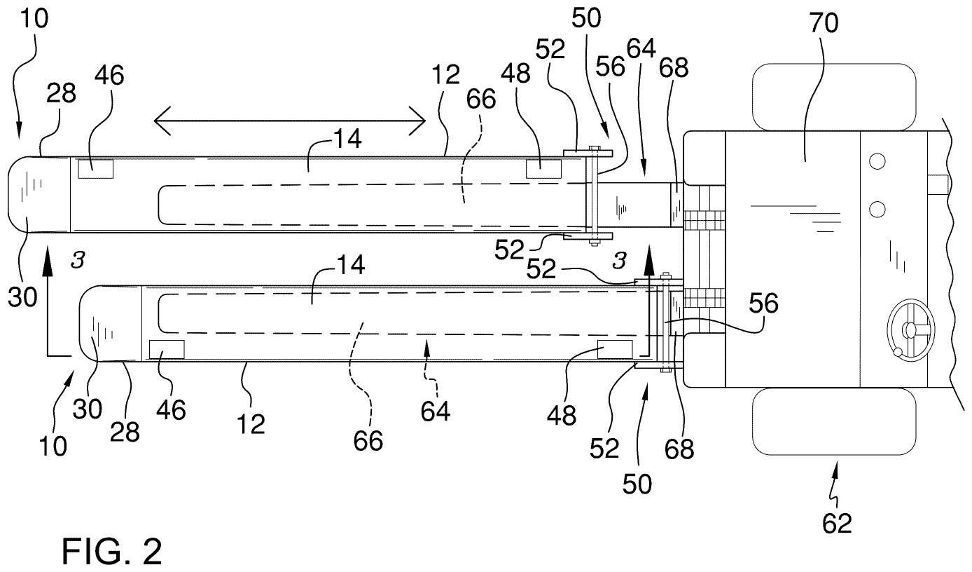

In use, the stop 32 is positioned in the body 12 and the stop opening door 46 is shut to remain clear of the load 72 or other obstructions under which the prong 64 and the body 12 travel. The stop opening door 46 also keeps dust and other debris out of the interior space 16 of the body 12. The stop 32 may be urged into the deployed position 36 through activating the actuator 38. For example, the protrusion 42 may be pressed down when the load 72 is placed against the actuator opening door 48 in the embodiment shown in FIGS. 1 through 7. For the embodiment depicted in FIG. 8, the user interface 58 may receive input which directs the motor 44 or other drive mechanism to urge the stop 32 into the deployed position 36. With reference to FIG. 9, the sensor 60 of that embodiment activates the motor 44 when it senses the load 72 being placed on the body 12. When the stop 32 is in the deployed position 36, it retains the load 72 on the upper surface 14 of the body 12. When the stop 32 is positioned in the stored position 34, the stop 32 discontinues retaining the load 72 on the upper surface 14. As shown in FIG. 2, two instances of the load retaining apparatus 10 may be used on two prongs 64 of the forklift 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A load retaining apparatus comprising:
a body having an upper surface for supporting a load, the body defining a stop-receiving opening in the upper surface of the body;
a stop being movably mounted to the body, the stop being movable between a stored position and a deployed position, the stop being positioned below the upper surface of the body when the stop is in the stored position, the stop extending upwardly through the stop-receiving opening of the body when the stop is in the deployed position; and
an actuator operatively coupled to the stop, the actuator being configured to move the stop from the stored position to the deployed position when the load is positioned on the upper surface of the body.

2. The load retaining apparatus of claim 1, wherein the body defines an interior space therein, the body defining an opening to the interior space at the back end of the body, the interior space being sized and configured to receive a prong of a forklift therein through the opening.

3. The load retaining apparatus of claim 2, further comprising a mounting assembly coupled to the body at the back end, the mounting assembly being configured to attach the body to the prong of the forklift.

4. The load retaining apparatus of claim 3, wherein the mounting assembly comprises a pair of plates spaced laterally from each other with respect to the body, each plate of the pair of plates defining hole, the holes of the pair of plates being aligned with each other, the hole of each plate of the pair of plates being configured to receive a fastener therethrough.

5. The load retaining apparatus of claim 1, wherein the body has a front portion with a top surface which is angled downwardly from the upper surface of the body to a front end of the body.

6. The load retaining apparatus of claim 1, wherein the stop is biased toward the stored position.

7. The load retaining apparatus of claim 1, further comprising a stop opening door coupled to the body, the stop opening door being movable to alternately open and close the stop-receiving opening.

8. The load retaining apparatus of claim 1, wherein:
the body defines an actuator-receiving opening in the upper surface of the body, the actuator-receiving opening being positioned closer to a back end of the body than the stop-receiving opening; and
the actuator comprises a protrusion mechanically coupled to the stop, the protrusion being movable with respect to the body through the actuator-receiving opening, the protrusion extending through the actuator-receiving opening when the stop is positioned in the stored position, the protrusion being depressible through the actuator-receiving opening to urge the stop to the deployed position.

9. The load retaining apparatus of claim 8, wherein the actuator further comprises a lever coupling the protrusion to the stop, the lever being pivotably mounted to the body.

10. The load retaining apparatus of claim 8, further comprising an actuator opening door coupled to the body, the actuator opening door being movable to alternately open and close the actuator-receiving opening.

11. The load retaining apparatus of claim 1, wherein the actuator comprises a drive mechanism operatively coupled to the stop, further comprising a user interface operatively coupled to the drive mechanism, the user interface being positioned remotely from the body.

12. The load retaining apparatus of claim 11, wherein the actuator further comprises a lever pivotably mounted to the body, the lever coupling the drive mechanism to the stop, the drive mechanism comprising a motor.

13. The load retaining apparatus of claim 1, wherein the actuator comprises a drive mechanism operatively coupled to the stop, further comprising a sensor operatively coupled to the drive mechanism, the sensor being configured to detect when the load is positioned on the upper surface of the body, the drive mechanism being configured to urge the stop toward the deployed position in response to the sensor detecting the load being positioned on the upper surface of the body.

14. The load retaining apparatus of claim 13, wherein the actuator further comprises a lever pivotably mounted to the body, the lever coupling the drive mechanism to the stop, the drive mechanism comprising a motor.

15. A load retaining apparatus comprising:
a body having an upper surface for supporting a load, the body defining a stop-receiving opening in the upper surface of the body, the body defining an interior space therein, the body defining an opening to the interior space at the back end of the body, the interior space being sized and configured to receive a prong of a forklift therein through the opening, the body having a front portion with a top surface which is angled downwardly from the upper surface of the body to a front end of the body;
a stop being movably mounted to the body, the stop being movable between a stored position and a deployed position, the stop being positioned below the upper surface of the body when the stop is in the stored position, the stop extending upwardly through the stop-receiving opening of the body when the stop is in the deployed position, the stop being biased toward the stored position;
an actuator operatively coupled to the stop, the actuator being configured to move the stop between the stored position and the deployed position when the load is positioned on the upper surface of the body;
a stop opening door coupled to the body, the stop opening door being movable to alternately open and close the stop-receiving opening;
a mounting assembly coupled to the body at the back end, the mounting assembly being configured to attach the body to the prong of the forklift, the mounting assembly comprising a pair of plates spaced laterally from each other with respect to the body, each plate of the pair of plates defining a pair of holes, each hole of the pair of holes of each plate aligning with an associated hole of the pair of holes of another plate of the pair of plates, each hole being configured to receive a fastener therethrough.

16. The load retaining apparatus of claim 15:
wherein the body defines an actuator-receiving opening in the upper surface of the body, the actuator-receiving opening being positioned closer to a back end of the body than the stop-receiving opening;
wherein the actuator comprises a lever and a protrusion, the lever coupling the protrusion to the stop, the lever being pivotably mounted to the body, the protrusion being movable with respect to the body through the actuator-receiving opening, the protrusion extending through the actuator-receiving opening when the stop is positioned in the stored position, the protrusion being depressible through the actuator-receiving opening to urge the stop to the deployed position; and
further comprising an actuator opening door coupled to the body, the actuator opening door being movable to alternately open and close the actuator-receiving opening.

17. The load retaining apparatus of claim 15 wherein the actuator comprises:
a lever pivotably mounted to the body and coupled to the stop; and
a motor coupled to the lever, the motor being operable to move the stop via the lever.

18. The load retaining apparatus of claim 17, further comprising a user interface operatively coupled to the drive mechanism, the user interface being positioned remotely from the body.

19. The load retaining apparatus of claim 17, a sensor operatively coupled to the motor, the sensor being configured to detect when the load is positioned on the upper surface of the body, the motor being configured to urge the stop toward the deployed position in response to the sensor detecting the load being positioned on the upper surface of the body.
